(19) United States
(12) Patent Application Publication
(10) Pub. No.: US 2024/0335903 A1
(43) Pub. Date: Oct. 10, 2024

(54) LOW SPEED FRICTION STIR PROCESSING SHOULDER

(71) Applicant: Mazak Corporation, Florence, KY (US)

(72) Inventors: Russell J. Steel, Provo, UT (US); Rodney Dale Fleck, Provo, UT (US)

(21) Appl. No.: 18/131,268

(22) Filed: Apr. 5, 2023

(51) Int. Cl. B23K 20/12

(52) U.S. Cl. CPC B23K 20/1255

(57) ABSTRACT

A friction-stir processing tool includes a pin, a shoulder, and a bearing surface. The pin and shoulder are rotatable around a rotational axis. The bearing surface is between the shoulder and pin, and the bearing surface allows the shoulder and pin to rotate independently relative to one another around the rotational axis on the bearing surface.

### CROSS-REFERENCE TO RELATED APPLICATIONS

N/A

### BACKGROUND

Friction stir processing (“FSP”) of metals has been used to attach weldable materials to one another in a solid-state joining process. FSP uses the motion of a pin pressed against the surface of a weldable material to generate heat and friction to move the weldable material. The material can plasticize and physically stir together with a second material to which the first material is joined. A pin, a pin and shoulder, or another “FSP tool” may be rotated in contact with a workpiece. A force is applied to the FSP tip to urge the FSP tool against the workpiece. The FSP tool is moved along the workpiece to stir the material of the workpiece. The physical process of mixing material from two plates joins the plates.

FSP joins weldable materials in a solid-state process that avoids many of the potential defects of other welding processes. For example, FSP produces a stirred region along the path of the tool that is generally indistinguishable from the original material. FSP may be performed without the inclusion of an additional material or use of shield gasses. Some welding methods, such as metal-inert gas (“MIG”) welding, may introduce an additional material to create a bond. Other welding methods, such as tungsten-inert gas (“TIG”) welding, may use a non-consumable contact point to heat one or more workpieces. However, the heating may cause the one or more workpieces to attain a liquid phase and risk a phase change in the one or more workpieces. A phase change may compromise the integrity of the bond and, potentially, the workpiece, itself. To limit the possibility of a phase change or other reaction, TIG welding and similar processes utilize an inert gas “shield” around the contact area.

Conventional FSP applies a compressive force using a shoulder radially surrounding the bit to compress the workpiece and generate heat, softening and circulating the workpiece material. The additional heat can alter the microstructure and change the material properties of the workpiece material.

### SUMMARY

In some embodiments, a friction-stir processing tool includes a pin, a shoulder, and a bearing surface. The pin and shoulder are rotatable around a rotational axis. The bearing surface is between the shoulder and pin, and the bearing surface allows the shoulder and pin to rotate independently relative to one another around the rotational axis on the bearing surface.

In some embodiments, friction-stir processing device includes a pin, a shoulder, a bearing surface, and a thermal element. The pin and shoulder are rotatable around a rotational axis. The bearing surface is between the shoulder and pin, and the bearing surface allows the shoulder and pin to rotate independently relative to one another around the rotational axis on the bearing surface. The shoulder has a contact surface in a first axial direction. The thermal element is positioned on a top surface of the shoulder axially opposite the contact surface.

In some embodiments, a friction-stir processing tool includes a pin, an asymmetric shoulder, and a bearing surface. The pin and shoulder are rotatable around a rotational axis. The bearing surface is between the shoulder and pin, and the bearing surface allows the shoulder and pin to rotate independently relative to one another around the rotational axis on the bearing surface.

This summary is provided to introduce a selection of concepts that are further described below in the detailed description. This summary is not intended to identify key or essential features of the claimed subject matter, nor is it intended to be used as an aid in limiting the scope of the claimed subject matter.

Additional features and advantages of embodiments of the disclosure will be set forth in the description which follows, and in part will be obvious from the description, or may be learned by the practice of such embodiments. The features and advantages of such embodiments may be realized and obtained by means of the instruments and combinations particularly pointed out in the appended claims. These and other features will become more fully apparent from the following description and appended claims, or may be learned by the practice of such embodiments as set forth hereinafter.

### BRIEF DESCRIPTION OF THE DRAWINGS

In order to describe the manner in which the above-recited and other features of the disclosure can be obtained, a more particular description will be rendered by reference to specific embodiments thereof which are illustrated in the appended drawings. For better understanding, the like elements have been designated by like reference numbers throughout the various accompanying figures. While some of the drawings may be schematic or exaggerated representations of concepts, other drawings should be considered as drawn to scale for example embodiments. Understanding that the drawings depict some example embodiments, the embodiments will be described and explained with additional specificity and detail through the use of the accompanying drawings in which:

FIG. 1 is a perspective view of a friction stir processing (FSP) system, according to some embodiments of the present disclosure;

FIG. 2 is a is a perspective view of an FSP system welding a butt joint, according to some embodiments of the present disclosure;

FIG. 3 is a perspective view of an FSP system welding a lap joint, according to some embodiments of the present disclosure;

FIG. 4 is a side cross-sectional view of an FSP tool, according to some embodiments of the present disclosure;

FIG. 5 is a side cross-sectional view of an FSP tool with thrust and race bearings, according to some embodiments of the present disclosure;

FIG. 6 is a side cross-sectional view of an FSP tool with a bearing surface angle between 0° and 90°, according to some embodiments of the present disclosure;

FIG. 7-1 is a perspective view of an FSP tool including a curved shoulder, according to some embodiments of the present disclosure;

FIG. 7-2 is a side cross-sectional view of the FSP tool of FIG. 7-1 welding a workpiece;

FIG. 8-1 is a perspective view of an FSP tool including a shoulder with multiple contact surfaces, according to some embodiments of the present disclosure;

FIG. 8-2 is a side cross-sectional view of the FSP tool of FIG. 8-1 corner welding workpieces;

FIG. 8-3 is a side cross-sectional view of the FSP tool of FIG. 8-1 T-welding workpieces;

FIG. 9 is a perspective view of an FSP tool with a shoulder including heating thermal elements, according to some embodiments of the present disclosure;

FIG. 10 is a perspective view of an FSP tool with a shoulder including cooling thermal elements, according to some embodiments of the present disclosure; and

FIG. 11 is a top view of an FSP tool with an asymmetric shoulder, according to some embodiments of the present disclosure.

### DETAILED DESCRIPTION

This disclosure generally relates to devices, systems, and methods for increasing efficiency of a friction stir processing (FSP) tool for friction stir welding, joining, processing, or other friction stirring procedures. More particularly, the present disclosure relates to FSP of workpieces at lower temperatures than conventional FSP. In some embodiments, a tool holder according to the present disclosure supports a tool including a bit and a shoulder where the shoulder can rotate relative to the pin. For example, the tool may include a bearing element positioned radially between the pin and the shoulder (in the radial direction relative to a rotational axis of the tool) that allows the shoulder to rotate around the rotational axis at a lower velocity than the bit. In some examples, the shoulder rotates at a lower velocity than the bit relative to the workpiece during FSP. In at least one example, the shoulder remains rotationally stationary relative to a workpiece surface while the pin rotates during FSP. By including a rotationally independent shoulder connected to the tool and not directly connected to the tool holder or other portion of a FSP system, some embodiments of tools according to the present disclosure can be retrofit to existing FPS systems without a need for a dedicated device with a stationary shoulder. For example, some embodiments of tools according to the present disclosure can be connected to a milling or machining system, such as a conventional computer number control (CNC) system and experience benefits of FSP with a low-speed or stationary shoulder.

In some embodiments, the FSP bit has a conical (including frustoconical), curved, or other non-cutting tip. The tip of the FSP bit may be plunged into a workpiece with an axial force that displaces workpiece material from the stirred region of the workpiece and/or joint. In some embodiments, a holder of the FSP tool includes one or more cutting elements to cut or otherwise remove flash from the surface of the workpiece around the stirred region. In other embodiments, the holder includes one or more burnishers to compress and/or burnish a surface of the workpiece around the stirred region. In some embodiments according to the present disclosure, a shoulder rotating at a lower or substantially zero rotational velocity during FSP can reduce the amount of flash produced and which needs to be removed.

In some embodiments, the penetration of the FSP bit by displacement of workpiece material instead of cutting into the workpiece material may produce greater amounts of movement of the workpiece material. In some examples, the FSP tool may produce thermal energy upon displacement in addition to the rotation of the FSP tool in contact with the workpiece. The FSP tool may then frictionally drag the workpiece material to flow the workpiece material in substantially circular motion with the rotation of the FSP tool work surface. In other examples, the FSP tool includes one or more surface features on a pin that mechanically engage with the workpiece material to flow the workpiece material. The increased flow rate may produce a stronger weld and/or allow increased translational speeds across the workpiece surface to complete a weld in less time. While the FSP bit flows the workpiece material during FSP, a shoulder rotating at a lower or substantially zero rotational velocity during FSP can reduce the amount of heat produced and limit the heat affected region of the workpiece material and/or allow the FSP to occur at a lower overall temperature of the weld. In some embodiments, the shoulder can include additional thermal elements to heat or cool the shoulder, further altering the temperature and size of the heat affected zone.

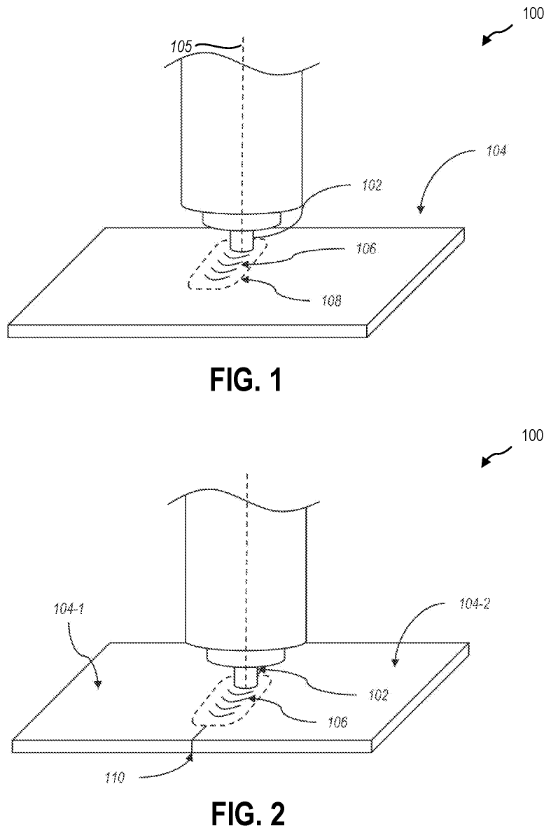

FIG. 1 illustrates an embodiment of a FSP system 100 with a FSP tool 102 in contact with a workpiece 104. Rotation of the FSP tool 102 around a rotational axis 105 in contact with the workpiece 104 may stir the workpiece 104 in a stirred zone 106 and create a heat affected zone 108 beyond the stirred zone 106. In some embodiments, FSP stirs a workpiece 104 to refine the grain structure in the stirred zone and/or the heat affected zone of the workpiece material. For example, the crystalline structural of the workpiece material may be at least partially dependent on the manufacturing of the workpiece. The as-manufactured grain structure may be undesirable for a finished part. In some embodiments, FSP processes one or more workpieces with a reusable bit. In some embodiments, a consumable bit is used in the FSPing of one or more workpieces.

In some examples, a cast workpiece has a random orientation (i.e., no texture) with a relatively large grain size with little to no deformation within each grain. FSP of the cast aluminum may refine the grain size to produce a smaller average grain size (increasing the boundary density of the microstructure). FSP of the cast aluminum may further produce internal strain within the grains. Increases in one or both of the grain boundary density and the internal strain may increase the hardness of the aluminum.

In other examples, an extruded or rolled workpiece exhibits a preferred orientation to the grain structure (e.g., a <101> texture or a <001> texture, respectively in aluminum) that may be undesirable in the finished part. For example, an extruded texture in an aluminum rod may increase the mechanical wear rate of the aluminum when used as an axle. FSP of the aluminum may mechanically alter the grain structure of the aluminum rod and/or remove the extruded texture of the rod surface. Orientation textures may affect other mechanical or chemical properties of the workpiece, such as anisotropic hardness or toughness, or oxidation rates.

In other embodiments, FSP refers to friction stir welding of a first workpiece to a second workpiece. For example, FIG. 2 illustrates the FSP system 100 and FSP tool 102 of FIG. 1 stir welding a butt joint. A first workpiece 104-1 may be positioned contacting a second workpiece 104-2 in a butt joint 110, and the first workpiece 104-1 and second workpiece 104-2 may be joined along the butt joint 110 by FSP. The FSP tool 102 may flow first workpiece material and second workpiece material in a circular direction and perpendicular to the butt joint 110 in the stirred zone 106 to transfer material between the first workpiece 104-1 and second workpiece 104-2, mechanically joining the first workpiece 104-1 and second workpiece 104-2 along the butt joint 110.

Stir welding is a solid-state joining process that plastically moves material of the first workpiece 104-1 and second workpiece 104-2 to interlock the first workpiece 104-1 and second workpiece 104-2 at a microstructural level. In some embodiments, the first workpiece 104-1 and second workpiece 104-2 are the same material. For example, the first workpiece 104-1 and the second workpiece 104-2 may be both a AA 6065 aluminum alloy. In other embodiments, the first workpiece 104-1 and second workpiece 104-2 are different materials. For example, the first workpiece 104-1 may be a single-phase aluminum alloy, and the second workpiece 104-2 may be a single-phase copper alloy. In other examples, the first workpiece 104-1 is an AA 6063 aluminum alloy and the second workpiece 104-2 is an AA 7075 aluminum alloy.

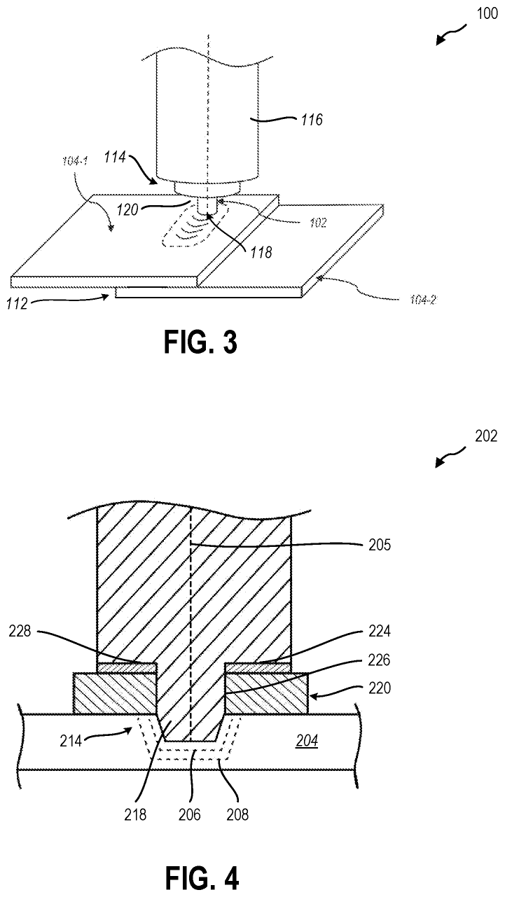

In yet another embodiment, stir welding by FSP includes friction stirring of a first workpiece and a second workpiece adjacent one another in a lap joint, such as the embodiment illustrated in FIG. 3. The FSP tool 102 may be positioned contacting a surface of the first workpiece 104-1 and the FSP tool 102 may be plunged into the first workpiece 104-1 and, optionally, the second workpiece 104-2 to plastically move first workpiece material and second workpiece material to interlock the first workpiece 104-1 and the second workpiece 104-2 at the lap joint 112.

In some embodiments, a lap joint 112 weld by FSP may require greater axial loads from a tool holder 116 than a butt joint weld. The increased axial load may generate greater thermal energy and greater flow of material when a non-cutting FSP bit is used to displace workpiece material. In some embodiments of FSP tools 102 according to the present disclosure, a low speed shoulder rotating at a lower or substantially zero rotational velocity during FSP can reduce the amount of heat to manage heat generated under higher axial loads.

The axial compression force downward toward the workpieces 104-1, 104-2 may be in a range having an upper value, a lower value, or upper and lower values including any of 1,000 lbs. (4.45 kN), 2,000 lbs. (8.90 kN), 4,000 lbs. (17.8 kN), 6,000 lbs. (26.7 kN), 8,000 lbs. (35.6 kN), 10,000 lbs. (44.5 kN), 15,000 lbs. (66.8 kN), 20,000 lbs. (89.0 kN), greater than 20,000 lbs. (89.0 kN), or any values therebetween. For example, the axial force may be greater than 1,000 lbs. (4.45 kN). In other examples, the axial force may be less than 20,000 lbs. (89.0 kN). In yet other examples, the axial force may be between 1,000 lbs. (4.45 kN) and 20,000 lbs. (89.0 kN). In further examples, the axial force may be between 1,000 lbs. (4.45 kN) and 10,000 lbs. (44.5 kN). In at least one example, the axial force may be between 3,750 lbs. (16.7 kN) and 4,250 lbs. (18.9 kN), and in a particular embodiment is 4,000 lbs. (17.8 kN).

In some embodiments, the bit 114 includes or is made of a ferrous alloy, such as tool steel, a nickel alloy (e.g., a nickel superalloy), an aluminum alloy (e.g., AA 6065), or any other material that is metallurgically compatible with the workpiece to which the FSP bit 114 is intended to interact. For example, the bit 114 may be metallurgically compatible with both workpieces 104-1, 104-2 in a butt joint. In other examples, the bit 114 is metallurgically compatible with the bottom workpiece (i.e., the second workpiece 104-2) in a lap joint 112. In some embodiments, the bit 114 has one or more coatings to improve the metallurgical compatibility of the bit 114 and the workpiece(s) 104-1, 104-2. In other embodiments, the bit 114 has one or more coatings to improve the erosion and/or wear resistance of the bit 114. In yet other embodiments, the bit 114 has one or more coatings to improve the corrosion resistance of the bit 114.

In some embodiments, the displacement of workpiece material from the workpieces 104-1, 104-2 at the lap joint 112 disturbs and flow workpiece material within the stirred zone 106 even before any rotation of the bit 114 and stirring of the workpiece material. Hence, penetration of the bit 114 by displacement, in contrast to cutting, may allow for greater total movement of workpiece material, increasing the homogeneity and strength of the resulting welds.

The geometry of the bit 114 (including the pin 118, the shoulder(s) 120, or other working surfaces of the bit 114) may affect the axial force with which the bit 114 is forced toward the workpiece(s) 104-1, 104-2 during FSP. The axial force applied will ensure the bit 114 will plunge into the workpieces 104-1, 104-2 and displace material during FSP. For the FSP to complete with minimal or no defects, the axial force should be approximately constant such that the penetration depth of the bit 114 in the workpieces 104-1, 104-2 is approximately constant.

In some embodiments, the pin 118 and the shoulder 120 are rotationally independent of one another. For example, the pin 118 and the shoulder 120 may each be rotatable around the rotational axis 105 independently of one another, allowing the pin 118 to rotate around the rotational axis 105 while the shoulder 120 remains stationary or allowing the pin 118 to remain stationary while the shoulder 120 rotates around the rotational axis 105. In some embodiments, a friction or drag force between the pin 118 and the shoulder 120 may impart a torque between the two components when one rotates relative to the other, but this should be understood to be rotationally independent despite the presence of friction or drag.

The pin and shoulder have a bearing surface between at least part of the pin and shoulder. For example, a bearing surface and/or element may be positioned axially (e.g., a thrust bearing) between a portion of the shoulder and a portion of the pin (or a tool body coupled to or integrally formed with the pin). In another example, a bearing surface and/or element may be positioned radially (e.g., a race bearing) between a portion of the shoulder and a portion of the pin. In some embodiments, the bearing surface is or includes a surface of the shoulder or the pin. For example, the pin and/or shoulder may be made of or include an ultrahard material, such as a polycrystalline diamond (PCD) or cubic boron nitride (cBN) or other ultrahard material. A surface of the pin or shoulder may be sufficiently wear resistant and/or have a low coefficient of friction to allow the shoulder and pin to rotate relative to one another directly on a bearing surface of the pin or shoulder material without an additional element or material therebetween.

In some embodiments, a discrete bearing material may be applied to a surface of the pin and/or shoulder to increase the wear resistance and/or decrease the coefficient of friction between the pin and shoulder. For example, a pin and shoulder (as described herein) may be or include a ferrous material, and a bearing material may be positioned between at least a portion of the pin and shoulder to increase the wear resistance and/or decrease the coefficient of friction therebetween. In at least one example, a diamond-like coating (DLC) is applied to the shoulder such that the DLC is a bearing element between the shoulder and the pin. In at least another example, an annulus of PCD is positioned around the pin and between the pin and the shoulder as a bearing element between the shoulder and the pin.

In some embodiments, the bearing element is rotationally fixed relative to the pin, such as a bearing material applied to a surface of the pin. In some embodiments, the bearing element is rotationally fixed relative to the shoulder, such as a bearing material applied to a surface of the shoulder. In some embodiments, the bearing element is rotationally independent of the shoulder and the pin, such as an annulus of PCD positioned between a surface of the pin and a surface of the shoulder without being coupled to either of the pin or shoulder.

The bearing element may include one or more movable or rotatable components, such as a roller bearing (e.g., cylindrical, conical, frustoconical) or a ball (e.g., spherical) bearing. In some embodiments, a race bearing including a plurality of ball bearings is positioned radially between a portion of the shoulder and a portion of the pin. In some embodiments, a race bearing including a plurality of roller bearings is positioned radially between a portion of the shoulder and a portion of the pin. In some embodiments, a thrust bearing including a plurality of ball bearings is positioned radially between a portion of the shoulder and a portion of the pin. In some embodiments, a thrust bearing including a plurality of roller bearings is positioned radially between a portion of the shoulder and a portion of the pin. In some embodiments, the tool includes a combination of any of the aforementioned bearing elements.

FIG. 4 is a side cross-sectional view of an embodiment of a tool 202 according to the present disclosure. The tool 202 includes bit 214 with a bearing element between the pin 218 and the shoulder 220. An axial bearing surface 224 includes a bearing material 228 positioned between the pin 218 and the shoulder 220 in the axial direction (e.g., in the direction of the rotational axis 205). In some embodiments, a bearing material 228, such as an ultrahard material and/or a low coefficient of friction material, is positioned axially between the pin 218 and the shoulder 220 to reduce wear between the pin 218 and the shoulder 220 under the high axial loads during FSP. It should be understood that a low coefficient of friction material is any material or coating that reduces the coefficient of friction from that of the pin directly contacting the shoulder without the low coefficient of friction material present.

The bit 214 further has a radial bearing surface 226 between the pin 218 and the shoulder 220 in the radial direction (e.g., in the direction perpendicular to the rotational axis 205) that allows the pin 218 to rotate relative to the shoulder 220. The radial bearing surface 226 of FIG. 4 is a direct contact between the pin 218 and the shoulder 220. In some embodiments, the bearing surface includes a lubricant applied therein to reduce friction and/or wear at the bearing surface. In some embodiments, the radial bearing surface 226 includes a bearing material or other bearing element positioned thereon.

In some embodiments, the pin 218 penetrates into the workpiece 204 and the shoulder 220 contacts a surface of the workpiece 204. In at least some embodiments, the pin 218 stirs the workpiece material and creates a stirred zone 206. An associated heat-affected zone 208 around the stirred zone 206 is created proximate the pin 218 and not the shoulder 220, as the shoulder remains stationary and/or rotates at a lesser velocity than the pin 218. The heat affected zone 208 may, therefore, be smaller than with a conventional pin and shoulder.

FIG. 5 illustrates a bit 314 with a race bearing and thrust bearing between the pin 318 and the shoulder 320. A thrust bearing on the axial bearing surface 324 may include a movable bearing element, such as ball, conical, or frustoconical bearings 330, that allow the thrust bearing to support the axial load during FSP. The race bearing on the radial bearing surface 326 may include a movable bearing element, such as cylindrical bearings 332 or ball bearings, that allow the race bearing to support the transverse load during FSP. As describe herein, the heat generated by the stationary or low-speed shoulder 320 allows the heat-affected zone 308 to be smaller relative to a conventional shoulder.

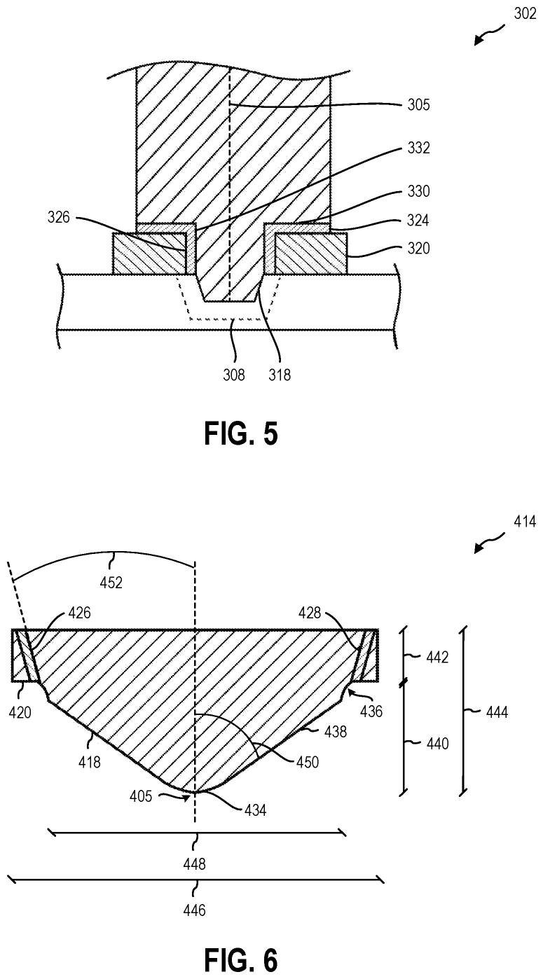

FIG. 5 illustrates an embodiment of a pin 318 with a planar tip, other embodiments of a bit 414 such as illustrated in FIG. 6 have a non-planar tip 434. In some embodiments, the bit design and/or geometry can further allow the bit to follow a workpiece surface by limiting bit penetration and allowing the biasing element to compress.

In some embodiments, the bit 414 has a generally conical pin 418 and substantially flat shoulder 420. In the same or other embodiments, a discontinuous transition 436 may be positioned between the pin 418 and the adjacent shoulder 420 to limit and/or disrupt workpiece material flow to the shoulder 420, thereby limiting rotation of the shoulder 420. In some embodiments, a bearing material 428 (or other bearing element) at the radial bearing surface 426 is rotationally independent of the pin 418 to limit additional stirring of the workpiece material away from the pin 418. In other embodiments, the pin 418 has a face 438 with one or more surface features thereon to engage with the workpiece material and increase flow of the workpiece material around the bit 414.

In some embodiments, a pin 418 includes one or more surface features to increase the movement of workpiece material during rotation of the pin 418. For example, a pin 418 may have a spiral surface feature to urge material in the stirred zone to circulate toward the radial center of the stirred zone instead of displacing radially away from the FSP bit 414. Such a pin surface feature may be beneficial in a lap joint friction stir weld to reduce and/or prevent thinning of the workpiece material in the weld zone. The spiral pin surface feature in combination with the angle of a linear portion and/or curved portion of the pin profile, may circulate workpiece material downward toward within the stirred region, as well. Such a surface feature may be beneficial in a lap friction stir weld to encourage stirred workpiece material from the first workpiece toward the second workpiece to form the lap joint.

The pin 418 in FIG. 6 has a pin height 440 that is relative to the shoulder height 442. In some embodiments, the pin height 440 is a percentage of the shoulder height 442 in a range having an upper value, a lower value, or upper and lower values including any of 50%, 60%, 70%, 80%, 90%, 100%, 110%, 120%, 130%, 140%, 150%, greater than 150%, or any values therebetween. For example, the pin height 440 may be greater than 50% of the shoulder height 442. In other examples, the pin height 440 may be less than 150% of the shoulder height 442. In yet other examples, the pin height 440 may be between 50% and 150% of the shoulder height 442. In further examples, the pin height 440 may be between 75% and 125% of the shoulder height 442.

In some embodiments, the pin 418 has a pin height 440 that is relative to a bit height 444. The pin height 440 may be in a range having an upper value, a lower value, or an upper and lower value including any of 5%, 10%, 15%, 20%, 25%, 30%, 40%, 45%, 50%, 60%, 70%, 80%, 90%, 100% of the bit height 444, or any values therebetween. For example, the pin height 440 may be greater than 10% of the bit height 444. In another example, the pin height 440 may be greater than 25% of the bit height 444. In yet another example, the pin height 440 may be greater than 50% of the bit height 444.

In some embodiments, the pin 418 has a pin height 440 in the longitudinal direction that is relative to a total diameter 446 of the bit 414. In FIG. 6, the total diameter 446 is a maximum diameter of the bit 414. The pin height 440 may be in a range having an upper value, a lower value, or an upper and lower value including any of 5%, 10%, 15%, 20%, 25%, 30%, 40%, 45%, 50%, 60%, 70%, 80%, 90%, 100% of the total diameter 446, or any values therebetween. For example, the pin height 440 may be greater than 5% of the total diameter 446. In another example, the pin height 440 may be less than 100% of the total diameter 446. In yet another example, the pin height 440 may be between 10% and 50% of the total diameter 446. In at least one example, the pin height 440 may be between 15% and 35% of the total diameter 446.

In other embodiments, the bit 414 has a bit height 444 that is related to the total diameter 446. The bit height 444 may be in a range having an upper value, a lower value, or an upper and lower value including any of 5%, 10%, 15%, 20%, 25%, 30%, 40%, 45%, 50%, 60%, 70%, 80%, 90%, 100% of the total diameter 446, or any values therebetween. For example, the bit height 444 may be greater than 5% of the total diameter 446. In another example, the bit height 444 may be less than 100% of the total diameter 446. In yet another example, the bit height 444 may be between 10% and 50% of the total diameter 446. In a further example, the bit height 444 may be between 25% and 40% of the total diameter 446. In at least one specific example, the bit height 444 may be greater than 100% of the total diameter 446, such as when joining thick workpieces and/or the site of the FSP placement has relatively small lateral clearance.

FIG. 6 illustrates a bit 414 with a tapered pin 418. In some embodiments, the pin 418 has a pin profile that is at least partially linear. In other embodiments, the pin 418 has a pin profile that is at least partially curved. In yet other embodiments, the pin 418 has a pin profile with a portion that is curved and a portion that is linear.

The bit 414 may have a non-cutting tip 434 that allows the bit 114 to penetrate a workpiece by displacing workpiece material without cutting the workpiece material. In some embodiments, the bit 414 has a tip 434 that is rounded. In other embodiments, the tip 434 may be pointed. In yet other embodiments, the tip 434 is planar and the face 438 is optionally angled, such that the pin 418 is frustoconical. In further embodiments, the tip 434 is planar across a pin diameter 448, such that the pin 418 is substantially cylindrical. In at least one embodiment, the tip 434 includes at least one pilot feature to assist in engaging with and penetrating into the workpiece material.

In other embodiments, the tip 434 is a cutting tip that includes one or more cutting features to accelerate penetration into the workpiece material. The cutting features may cut a pilot hole with a diameter less than a pin diameter 448, such that the pin 418 displaces workpiece material radially outside the pilot hole. For example, the cutting features may cut a pilot hole with a diameter 50% of the pin diameter 448, and the face 438 of the pin 418 may displace workpiece material outside of the pilot hole.

In some embodiments, the pin 418 has a pin diameter 448 that is related to the total diameter 446 of the bit 414. For example, the pin diameter 448 may be a percentage of the total diameter 446 in a range having an upper value, a lower value, or an upper and lower value including any of 5%, 10%, 15%, 20%, 25%, 30%, 40%, 45%, 50%, 60%, 70%, 80%, 90%, 100%, or any values therebetween. For example, the pin diameter 448 may be greater than 5% of the total diameter 446. In another example, the pin diameter 448 may be less than 100% of the total diameter 446. In yet another example, the pin diameter 448 may be between 10% and 90% of the total diameter 446. In at least one example, the pin diameter 448 may be between 25% and 75% of the total diameter 446.

In some embodiments, the pin 418 has a face angle 450 between a face 438 of the pin 418 and the rotational axis 405 that is in a range having an upper value, a lower value, or upper and lower values including any of 30°, 40°, 45°, 50°, 60°, 75°, 80°, 85°, 90°, or any values therebetween. For example, a face 438 may be oriented at a face angle 450 greater than 30°. In other examples, the face 438 is oriented at a face angle 450 less than 90°. In yet other examples, the face 438 is oriented a face angle 450 between 30° and 90°. In further examples, the face 438 is oriented at a face angle 450 between 45° and 80°. In at least one example, the face 438 is oriented at a face angle 450 of 60° to the rotational axis 405. In at least another example, the face 438 is oriented at a face angle 450 that is non-perpendicular to the rotational axis 405.

In some embodiments, the bearing surface (e.g., the radial bearing surface 426) between the pin 418 and the shoulder 420 is not only axially oriented or radially oriented. For example, the bearing surface may have an orientation relative to the rotational axis 405 that is between 0° and 90°. In some embodiments, a bearing surface angle 452 is in a range having an upper value, a lower value, or upper and lower values including any of 1°, 5° 10°, 20°, 30°, 40°, 45°, 50°, 60°, or any values therebetween. For example, a bearing surface angle 452 may be greater than 1°. In other examples, the bearing surface angle 452 may be less than 60°. In yet other examples, the bearing surface angle 452 may be between 1° and 60°. In further examples, the bearing surface angle 452 may be between 5° and 50°. In at least one example, the bearing surface angle 452 may be 45° to the rotational axis 405. In at least another example, the bearing surface angle 452 may be 30° to the rotational axis 405.

In some embodiments, bits according to the present disclosure allow the rotational locking of the shoulder to the workpiece. For example, different workpiece materials and/or joints have different surface geometries, such as a butt joint between segments of pipe of workpiece material, a corner weld of two sheets of workpiece material, or a T-weld of two or three pieces of workpiece material.

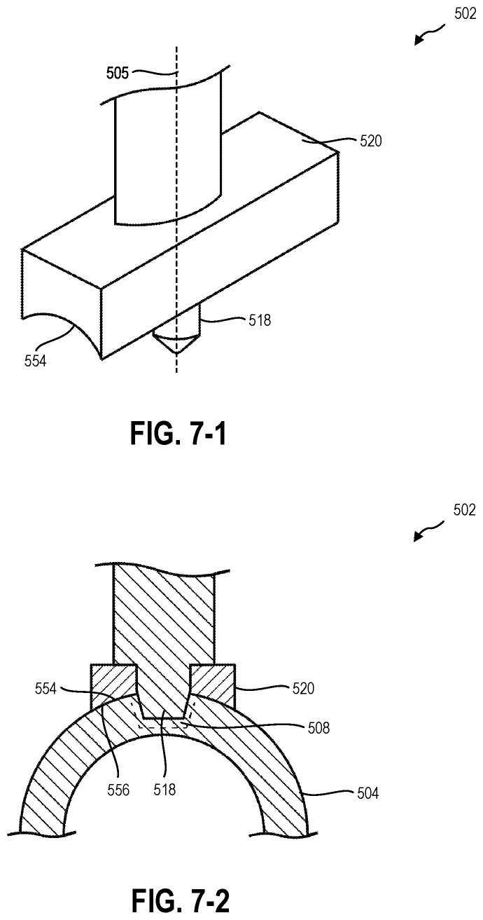

FIG. 7-1 is a perspective view of an embodiment of a tool 502 with a shoulder 520 configured to mechanically interact with a cylindrical workpiece and limit rotation of the shoulder relative to the workpiece during FSP. The shoulder 520, as described herein, can rotate around the rotational axis 505 of the tool 502 independently of and/or at a different velocity than the pin 518. A concave contact surface 554 of the shoulder 520 is configured to mechanically engage with a convex curved workpiece surface and rotationally lock the shoulder 520 with the workpiece.

FIG. 7-2 illustrates an embodiment of an FSP of a pipe workpiece 504 with the tool 502 of FIG. 7-1. The rotationally independent shoulder 520 of the tool 502 has a concave contact surface 554 that complementarily mates with an outer surface 556 of the workpiece to rotationally lock the shoulder 520 to the pipe workpiece 504. In such examples, the shoulder 520 can apply a compressive force to limit and/or prevent the formation of flash on the outer surface 556 of the workpiece 504 while the pin 518 FSPs the workpiece 504. For example, the tool 502 may be moved along a longitudinal seam weld or a circumferential butt weld of the pipe workpiece with the shoulder 520 remaining substantially rotationally stationary. The rotationally locked shoulder 520 relative to the workpiece 504 further limits the size of the heat affected zone 508.

While a curved contact surface 554 is described in relation to a concave contact surface 554 engaging with a convex upper surface 556 of a workpiece 504, it should be understood that a curved contact surface may be or include a convex contact surface configured to engage with a concave workpiece.

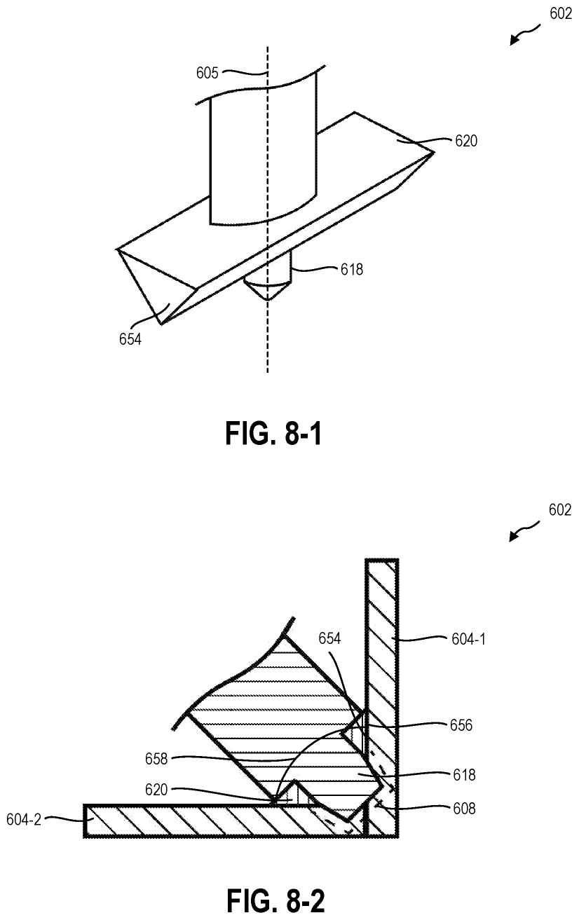

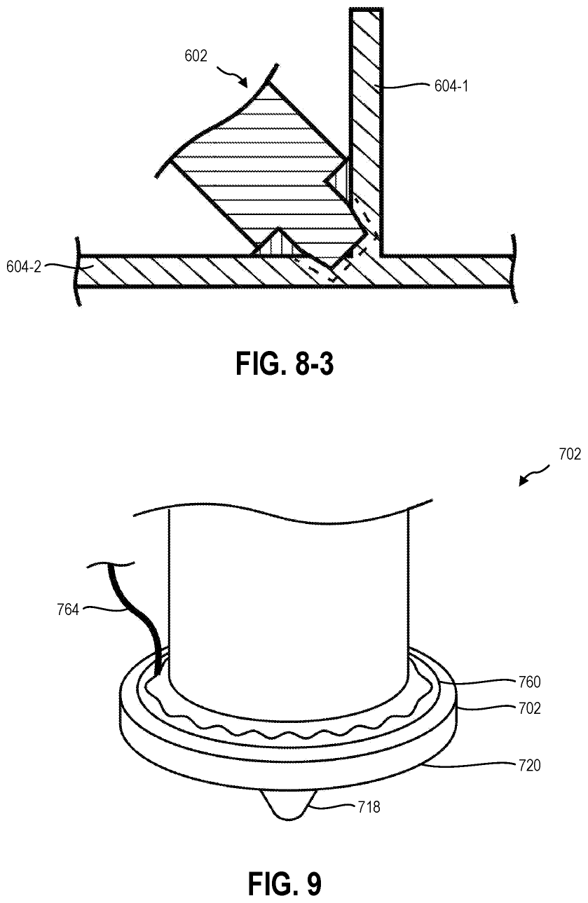

FIG. 8-1 is a perspective view of an embodiment of a tool 602 with a rotationally independent shoulder 620 configured to mechanically interact with a one or more workpieces forming a corner and limit rotation of the shoulder 620 relative to the workpiece during FSP. The shoulder 620, as described herein, can rotate around the rotational axis 605 of the tool 602 independently of and/or at a different velocity than the pin 618. A contact surface 654 of the shoulder 620 is oriented at an angle to the rotational axis 605 to mechanically engage with a workpiece surface when the rotational axis 605 is oriented at a non-perpendicular angle to the workpiece surface and rotationally lock the shoulder 620 with the workpiece. In the illustrated embodiment, the shoulder 620 includes two planar contact surface 654 oriented at equal angles relative to the rotational axis 605. However, in other embodiments, the shoulder 620 includes one contact surface 654 oriented at a non-perpendicular angle relative to the rotational axis 605. In yet other embodiments, the shoulder 620 includes more than two contact surfaces 654 oriented at a non-perpendicular angle relative to the rotational axis 605. In further embodiments, shoulder 620 includes at least two contact surfaces 654 oriented at a non-perpendicular angle relative to the rotational axis 605 where a first contact surface is oriented at a different angle than the second contact surface.

In some embodiments, at least two of the contact surfaces 654 of the shoulder 620 define a corner angle 658 in a range having an upper value, a lower value, or upper and lower values including any of 30°, 40°, 45°, 50°, 60°, 75°, 80°, 85°, 90°, 100°, 110°, 120°, 135°, or any values therebetween. For example, the shoulder 620 may define a corner angle 658 greater than 30°. In other examples, the shoulder 620 may define a corner angle 658 less than 135°. In yet other examples, the shoulder 620 may define a corner angle 658 between 30° and 135°. In further examples, the shoulder 620 may define a corner angle 658 between 60° and 120°. In at least one example, the shoulder 620 may define a corner angle 658 of 90°.

FIG. 8-2 illustrates an embodiment of a FSP of a corner weld on two workpieces with a rotationally independent shoulder 620 of the tool 602 of FIG. 8-1 rotationally locked to the workpieces 604-1, 604-2. The rotationally independent shoulder 620 of the tool 602 has two contact surfaces 654 that complementarily mate with an outer surface 656 of each workpiece 604-1, 604-2 to rotationally lock the shoulder 620 to the corner formed by the workpieces 604-1, 604-2. In such examples, the shoulder 620 can apply a compressive force to limit and/or prevent the formation of flash on the outer surface 656 of the workpieces 604-1, 604-2 while the pin 618 FSPs the workpieces 604-1, 604-2. For example, the tool 602 may be moved along a longitudinal corner weld of the workpieces 604-1, 604-2 with the shoulder 620 remaining substantially rotationally stationary. The rotationally locked shoulder 620 relative to the workpieces 604-1, 604-2 further limits the size of the heat affected zone 608. FIG. 8-3 illustrates an embodiment of a FSP with the tool 602 of FIG. 8-1 of a T-weld on two workpieces 604-1, 604-2 with a rotationally independent shoulder 620 rotationally locked to the workpieces 604-1, 604-2.

As described herein, a tool according to some embodiments of the present disclosure has one or more thermal elements positioned on the shoulder. In some examples, the thermal element is positioned on a top surface axially opposite the contact surface of the shoulder. In some examples, the thermal element is positioned on a radially outward surface or edge of the shoulder. In some embodiments, the thermal element is a heating element to heat the shoulder and/or the workpiece, such as pre-heating the workpiece before the pin FSPs the workpiece material. In some embodiments, the thermal element is a cooling element to cool the shoulder and/or the workpiece, such as cooling the workpiece material after the pin FSPs the workpiece material.

FIG. 9 is a perspective view of an embodiment of a tool 702 with a rotationally independent shoulder 720 relative to a pin 718. A heating thermal element 760 is positioned on a top surface 762 of the shoulder 720. Because the shoulder 720 rotates more slowly and/or remains stationary relative to the pin 718, in some embodiments, a heating thermal element 760 may have one or more conduits 764 connected thereto. For example, a stationary shoulder 720 may have an electrical conduit 764 (e.g., a wire) connecting a resistive heating thermal element 760 to a power source without the shoulder 720 pulling on the wire. In another example, a stationary shoulder 720 may have a fluid conduit 764 connecting a radiant heating thermal element 760 to a hot fluid source without the shoulder 720 pulling on the conduit.

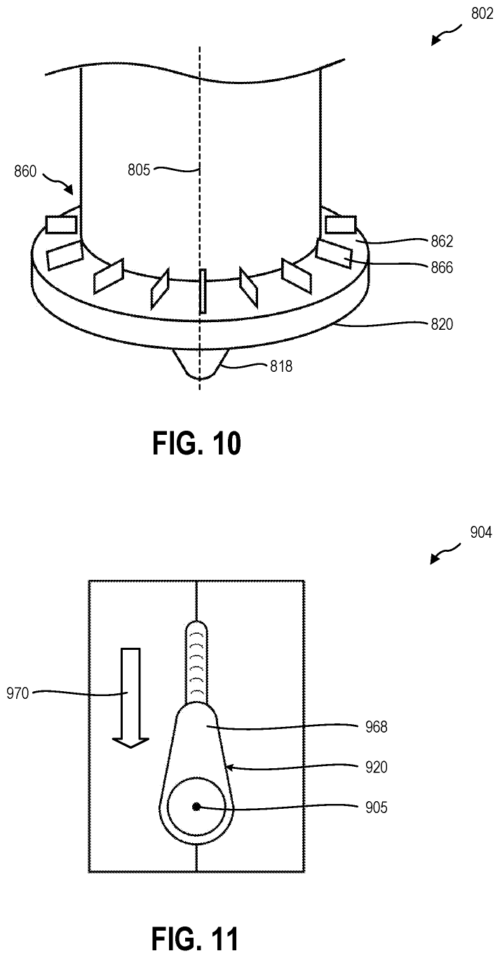

FIG. 10 is a perspective view of an embodiment of a tool 802 with a rotationally independent shoulder 820 relative to a pin 818. A cooling thermal element 860 is positioned on a top surface 862 of the shoulder 820. Because the shoulder 820 rotates more slowly and/or remains stationary relative to the pin 818, in some embodiments, a cooling thermal element 860 may have one or more conduits connected thereto. For example, a stationary shoulder 820 may have an electrical conduit (e.g., a wire) connecting a Peltier cooling thermal element to a power source without the shoulder 820 pulling on the wire. In another example, a stationary shoulder 820 may have a liquid conduit connecting a liquid cooling thermal element 860 to a cold liquid source without the shoulder 820 pulling on the conduit.

In some embodiments, the cooling thermal element 860 may be or include a passive cooling element 866, such as fins, pins, rods, and other surface features that increase surface area of the top surface to conduct and radiate away heat from the shoulder 820. In some embodiments rotation of the shoulder 820 around the rotational axis 805 during FSP (such as due to friction or drag with the pin 818) may cause the passive cooling element(s) 866 to move air or other fluid around the tool 802, further passively cooling at least a portion of the tool 802.

FIG. 11 is a top view of another embodiment of a tool 902. In some embodiments, the shoulder 920 is asymmetric relative to the rotational axis 905. In some embodiments, a surface area of the shoulder 920 is asymmetric relative to the rotational axis 905. For example, the increased surface area on one side of the shoulder 920 relative to the rotational axis 905 may produce a net frictional force on the shoulder 920, applying a torque around the rotational axis 905. In some embodiments, a mass of the shoulder 920 is asymmetric relative to the rotational axis 905. In conventional FSP tools with a shoulder that rotates at the speed of the bit, an asymmetric mass causes dangerously unstable oscillations. A stationary or low-speed shoulder 920 according to the present disclosure can allow for an asymmetric mass.

As the tool 902 is translated relative to the workpiece 904 (e.g., across a weld), the portion of the asymmetric shoulder 920 with a larger radius from the rotational axis (the foot 968) will experience a torque based on friction and the direction of movement 970 of the tool 902 across the workpiece 904. The foot 968 will trail behind relative to the direction of movement 970 of the tool across the workpiece 904, further limiting and/or preventing rotation of the shoulder 920 as the pin rotates during FSP.

### Industrial Applicability

This disclosure generally relates to devices, systems, and methods for increasing efficiency of a friction stir processing (FSP) tool for friction stir welding, joining, processing, or other friction stirring procedures. More particularly, the present disclosure relates to FSP of workpieces at lower temperatures than conventional FSP. In some embodiments, a tool holder according to the present disclosure supports a tool including a bit and a shoulder where the shoulder can rotate relative to the pin. For example, the tool may include a bearing element positioned radially between the pin and the shoulder (in the radial direction relative to a rotational axis of the tool) that allows the shoulder to rotate around the rotational axis at a lower velocity than the bit. In some examples, the shoulder rotates at a lower velocity than the bit relative to the workpiece during FSP. In at least one example, the shoulder remains rotationally stationary relative to a workpiece surface while the pin rotates during FSP. By including a rotationally independent shoulder connected to the tool and not directly connected to the tool holder or other portion of a FSP system, some embodiments of tools according to the present disclosure can be retrofit to existing FPS systems without a need for a dedicated device with a stationary shoulder. For example, some embodiments of tools according to the present disclosure can be connected to a milling or machining system, such as a conventional computer number control (CNC) system and experience benefits of FSP with a low-speed or stationary shoulder.

In some embodiments, the FSP bit has a conical (including frustoconical), curved, or other non-cutting tip. The tip of the FSP bit may be plunged into a workpiece with an axial force that displaces workpiece material from the stirred region of the workpiece and/or joint. In some embodiments, a holder of the FSP tool includes one or more cutting elements to cut or otherwise remove flash from the surface of the workpiece around the stirred region. In other embodiments, the holder includes one or more burnishers to compress and/or burnish a surface of the workpiece around the stirred region. In some embodiments according to the present disclosure, a shoulder rotating at a lower or substantially zero rotational velocity during FSP can reduce the amount of flash produced and which needs to be removed.

In some embodiments, the penetration of the FSP bit by displacement of workpiece material instead of cutting into the workpiece material may produce greater amounts of movement of the workpiece material. In some examples, the FSP tool may produce thermal energy upon displacement in addition to the rotation of the FSP tool in contact with the workpiece. The FSP tool may then frictionally drag the workpiece material to flow the workpiece material in substantially circular motion with the rotation of the FSP tool work surface. In other examples, the FSP tool includes one or more surface features on a pin that mechanically engage with the workpiece material to flow the workpiece material. The increased flow rate may produce a stronger weld and/or allow increased translational speeds across the workpiece surface to complete a weld in less time. While the FSP bit flows the workpiece material during FSP, a shoulder rotating at a lower or substantially zero rotational velocity during FSP can reduce the amount of heat produced and limit the heat affected region of the workpiece material and/or allow the FSP to occur at a lower overall temperature of the weld. In some embodiments, the shoulder can include additional thermal elements to heat or cool the shoulder, further altering the temperature and size of the heat affected zone.

In some embodiments, a pin and a shoulder of a bit are rotationally independent of one another. For example, the pin and the shoulder may each be rotatable around the rotational axis independently of one another, allowing the pin to rotate around the rotational axis while the shoulder remains stationary or allowing the pin to remain stationary while the shoulder rotates around the rotational axis. In some embodiments, a friction or drag force between the pin and the shoulder may impart a torque between the two components when one rotates relative to the other, but this should be understood to be rotationally independent despite the presence of friction or drag.

The pin and shoulder have a bearing surface between at least part of the pin and shoulder. For example, a bearing surface and/or element may be positioned axially (e.g., a thrust bearing) between a portion of the shoulder and a portion of the pin (or a tool body coupled to or integrally formed with the pin). In another example, a bearing surface and/or element may be positioned radially (e.g., a race bearing) between a portion of the shoulder and a portion of the pin. In some embodiments, the bearing surface is or includes a surface of the shoulder or the pin. For example, the pin and/or shoulder may be made of or include an ultrahard material, such as a polycrystalline diamond (PCD) or cubic boron nitride (cBN) or other ultrahard material. A surface of the pin or shoulder may be sufficiently wear-resistant and/or have a low coefficient of friction to allow the shoulder and pin to rotate relative to one another directly on a bearing surface of the pin or shoulder material without an additional element or material therebetween.

In some embodiments, a discrete bearing material may be applied to a surface of the pin and/or shoulder to increase the wear resistance and/or decrease the coefficient of friction between the pin and shoulder. For example, a pin and shoulder (as described herein) may be or include a ferrous material, and a bearing material may be positioned between at least a portion of the pin and shoulder to increase the wear resistance and/or decrease the coefficient of friction therebetween. In at least one example, a diamond-like coating (DLC) is applied to the shoulder such that the DLC is a bearing element between the shoulder and the pin. In at least another example, an annulus of PCD is positioned around the pin and between the pin and the shoulder as a bearing element between the shoulder and the pin.

In some embodiments, the bearing element is rotationally fixed relative to the pin, such as a bearing material applied to a surface of the pin. In some embodiments, the bearing element is rotationally fixed relative to the shoulder, such as a bearing material applied to a surface of the shoulder. In some embodiments, the bearing element is rotationally independent of the shoulder and the pin, such as an annulus of PCD positioned between a surface of the pin and a surface of the shoulder without being coupled to either of the pin or shoulder.

The bearing element may include one or more movable or rotatable components, such as a roller bearing (e.g., cylindrical, conical, frustoconical) or a ball (e.g., spherical) bearing. In some embodiments, a race bearing including a plurality of ball bearings is positioned radially between a portion of the shoulder and a portion of the pin. In some embodiments, a race bearing including a plurality of roller bearings is positioned radially between a portion of the shoulder and a portion of the pin. In some embodiments, a thrust bearing including a plurality of ball bearings is positioned radially between a portion of the shoulder and a portion of the pin. In some embodiments, a thrust bearing including a plurality of roller bearings is positioned radially between a portion of the shoulder and a portion of the pin. In some embodiments, the tool includes a combination of any of the aforementioned bearing elements.

In some embodiments, a tool includes bit with a bearing element between the pin and the shoulder. In some embodiments, an axial bearing surface includes a bearing material positioned between the pin and the shoulder in the axial direction (e.g., in the direction of the rotational axis). In some embodiments, a bearing material, such as an ultrahard material and/or a low coefficient of friction material, is positioned axially between the pin and the shoulder to reduce wear between the pin and the shoulder under the high axial loads during FSP. It should be understood that a low coefficient of friction material is any material or coating that reduces the coefficient of friction from that of the pin directly contacting the shoulder without the low coefficient of friction material present.

In some embodiments, the bit further has a radial bearing surface between the pin and the shoulder in the radial direction (e.g., in the direction perpendicular to the rotational axis) that allows the pin to rotate relative to the shoulder. In some embodiments, the radial bearing surface is a direct contact between the pin and the shoulder. In some embodiments, the bearing surface includes a lubricant applied therein to reduce friction and/or wear at the bearing surface. In some embodiments, the radial bearing surface includes a bearing material or other bearing element positioned thereon.

In some embodiments, the pin penetrates into the workpiece and the shoulder contacts a surface of the workpiece. In at least some embodiments, the pin stirs the workpiece material and creates a stirred zone. An associated heat-affected zone around the stirred zone is created proximate the pin and not the shoulder, as the shoulder remains stationary and/or rotates at a lesser velocity than the pin. The heat affected zone may, therefore, be smaller than with a conventional pin and shoulder.

A thrust bearing on the axial bearing surface may include a movable bearing element, such as ball, conical, or frustoconical bearings, that allow the thrust bearing to support the axial load during FSP. The race bearing on the radial bearing surface may include a movable bearing element, such as cylindrical bearings or ball bearings, that allow the race bearing to support the transverse load during FSP. As describe herein, the heat generated by the stationary or low-speed shoulder allows the heat-affected zone to be smaller relative to a conventional shoulder.

In some embodiments, the bit design and/or geometry can further allow the bit to follow a workpiece surface by limiting bit penetration and allowing the biasing element to compress. In some embodiments, the bit has a generally conical pin and substantially flat shoulder. In the same or other embodiments, a discontinuous transition may be positioned between the pin and the adjacent shoulder to limit and/or disrupt workpiece material flow to the shoulder, thereby limiting rotation of the shoulder. In some embodiments, a bearing material (or other bearing element) at the radial bearing surface is rotationally independent of the pin to limit additional stirring of the workpiece material away from the pin. In other embodiments, the pin has a face with one or more surface features thereon to engage with the workpiece material and increase flow of the workpiece material around the bit.

In some embodiments, a pin includes one or more surface features to increase the movement of workpiece material during rotation of the pin. For example, a pin may have a spiral surface feature to urge material in the stirred zone to circulate toward the radial center of the stirred zone instead of displacing radially away from the FSP bit. Such a pin surface feature may be beneficial in a lap joint friction stir weld to reduce and/or prevent thinning of the workpiece material in the weld zone. The spiral pin surface feature in combination with the angle of a linear portion and/or curved portion of the pin profile, may circulate workpiece material downward toward within the stirred region, as well. Such a surface feature may be beneficial in a lap friction stir weld to encourage stirred workpiece material from the first workpiece toward the second workpiece to form the lap joint.

In some embodiments, the pin has a pin height that is relative to the shoulder height. In some embodiments, the pin height is a percentage of the shoulder height in a range having an upper value, a lower value, or upper and lower values including any of 50%, 60%, 70%, 80%, 90%, 100%, 110%, 120%, 130%, 140%, 150%, greater than 150%, or any values therebetween. For example, the pin height may be greater than 50% of the shoulder height. In other examples, the pin height may be less than 150% of the shoulder height. In yet other examples, the pin height 440 may be between 50% and 150% of the shoulder height. In further examples, the pin height 440 may be between 75% and 125% of the shoulder height.

In some embodiments, the pin has a pin height that is relative to a bit height. The pin height may be in a range having an upper value, a lower value, or an upper and lower value including any of 5%, 10%, 15%, 20%, 25%, 30%, 40%, 45%, 50%, 60%, 70%, 80%, 90%, 100% of the bit height, or any values therebetween. For example, the pin height may be greater than 10% of the bit height. In another example, the pin height may be greater than 25% of the bit height. In yet another example, the pin height may be greater than 50% of the bit height.

In some embodiments, the pin has a pin height in the longitudinal direction that is relative to a total diameter of the bit. In some embodiments, the total diameter is a maximum diameter of the bit. The pin height may be in a range having an upper value, a lower value, or an upper and lower value including any of 5%, 10%, 15%, 20%, 25%, 30%, 40%, 45%, 50%, 60%, 70%, 80%, 90%, 100% of the total diameter, or any values therebetween. For example, the pin height may be greater than 5% of the total diameter. In another example, the pin height may be less than 100% of the total diameter. In yet another example, the pin height may be between 10% and 50% of the total diameter. In at least one example, the pin height may be between 15% and 35% of the total diameter.

In other embodiments, the bit has a bit height that is related to the total diameter. The bit height may be in a range having an upper value, a lower value, or an upper and lower value including any of 5%, 10%, 15%, 20%, 25%, 30%, 40%, 45%, 50%, 60%, 70%, 80%, 90%, 100% of the total diameter, or any values therebetween. For example, the bit height may be greater than 5% of the total diameter. In another example, the bit height may be less than 100% of the total diameter. In yet another example, the bit height may be between 10% and 50% of the total diameter. In a further example, the bit height may be between 25% and 40% of the total diameter. In at least one specific example, the bit height may be greater than 100% of the total diameter, such as when joining thick workpieces and/or the site of the FSP placement has relatively small lateral clearance.

In some embodiments, the pin has a pin profile that is at least partially linear. In other embodiments, the pin has a pin profile that is at least partially curved. In yet other embodiments, the pin has a pin profile with a portion that is curved and a portion that is linear.

The bit may have a non-cutting tip that allows the bit to penetrate a workpiece by displacing workpiece material without cutting the workpiece material. In some embodiments, the bit has a tip that is rounded. In other embodiments, the tip may be pointed. In yet other embodiments, the tip is planar and the face is optionally angled, such that the pin is frustoconical. In further embodiments, the tip is planar across a pin diameter, such that the pin is substantially cylindrical. In at least one embodiment, the tip includes at least one pilot feature to assist in engaging with and penetrating into the workpiece material.

In other embodiments, the tip is a cutting tip that includes one or more cutting features to accelerate penetration into the workpiece material. The cutting features may cut a pilot hole with a diameter less than a pin diameter, such that the pin displaces workpiece material radially outside the pilot hole. For example, the cutting features may cut a pilot hole with a diameter 50% of the pin diameter, and the face of the pin may displace workpiece material outside of the pilot hole.

In some embodiments, the pin has a pin diameter that is related to the total diameter of the bit. For example, the pin diameter may be a percentage of the total diameter in a range having an upper value, a lower value, or an upper and lower value including any of 5%, 10%, 15%, 20%, 25%, 30%, 40%, 45%, 50%, 60%, 70%, 80%, 90%, 100%, or any values therebetween. For example, the pin diameter may be greater than 5% of the total diameter. In another example, the pin diameter may be less than 100% of the total diameter. In yet another example, the pin diameter may be between 10% and 90% of the total diameter. In at least one example, the pin diameter may be between 25% and 75% of the total diameter.

In some embodiments, the pin has a face angle between a face of the pin and the rotational axis 405 that is in a range having an upper value, a lower value, or upper and lower values including any of 30°, 40°, 45°, 50°, 60°, 75°, 80°, 85°, 90°, or any values therebetween. For example, a face may be oriented at a face angle greater than 30°. In other examples, the face is oriented at a face angle less than 90°. In yet other examples, the face is oriented a face angle between 30° and 90°. In further examples, the face is oriented at a face angle between 45° and 80°. In at least one example, the face is oriented at a face angle of 60° to the rotational axis. In at least another example, the face is oriented at a face angle 450 that is non-perpendicular to the rotational axis.

In some embodiments, the bearing surface (e.g., the radial bearing surface) between the pin and the shoulder is not only axially oriented or radially oriented. For example, the bearing surface may have an orientation relative to the rotational axis that is between 0° and 90°. In some embodiments, a bearing surface angle is in a range having an upper value, a lower value, or upper and lower values including any of 1°, 5° 10°, 20°, 30°, 40°, 45°, 50°, 60°, or any values therebetween. For example, a bearing surface angle may be greater than 1°. In other examples, the bearing surface angle may be less than 60°. In yet other examples, the bearing surface angle may be between 1° and 60°. In further examples, the bearing surface angle may be between 5° and 50°. In at least one example, the bearing surface angle may be 45° to the rotational axis. In at least another example, the bearing surface angle may be 30° to the rotational axis.

In some embodiments, bits according to the present disclosure allow the rotational locking of the shoulder to the workpiece. For example, different workpiece materials and/or joints have different surface geometries, such as a butt joint between segments of pipe of workpiece material, a corner weld of two sheets of workpiece material, or a T-weld of two or three pieces of workpiece material.

In some embodiments, a tool has a shoulder configured to mechanically interact with a cylindrical workpiece and limit rotation of the shoulder relative to the workpiece during FSP. The shoulder, as described herein, can rotate around the rotational axis of the tool independently of and/or at a different velocity than the pin. A concave contact surface of the shoulder is configured to mechanically engage with a convex curved workpiece surface and rotationally lock the shoulder with the workpiece.

In some embodiments, the rotationally independent shoulder of the tool has a concave contact surface that complementarily mates with an outer surface of a workpiece to rotationally lock the shoulder to the pipe workpiece. In such examples, the shoulder can apply a compressive force to limit and/or prevent the formation of flash on the outer surface of the workpiece while the pin FSPs the workpiece. For example, the tool may be moved along a longitudinal seam weld or a circumferential butt weld of the pipe workpiece with the shoulder remaining substantially rotationally stationary. The rotationally locked shoulder relative to the workpiece further limits the size of the heat affected zone.

While a curved contact surface is described in relation to a concave contact surface engaging with a convex upper surface of a workpiece, it should be understood that a curved contact surface may be or include a convex contact surface configured to engage with a concave workpiece.

In some embodiments, a tool has a rotationally independent shoulder configured to mechanically interact with a one or more workpieces forming a corner and limit rotation of the shoulder relative to the workpiece during FSP. The shoulder, as described herein, can rotate around the rotational axis of the tool independently of and/or at a different velocity than the pin. A contact surface of the shoulder is oriented at an angle to the rotational axis to mechanically engage with a workpiece surface when the rotational axis is oriented at a non-perpendicular angle to the workpiece surface and rotationally lock the shoulder with the workpiece. In the illustrated embodiment, the shoulder includes two planar contact surface oriented at equal angles relative to the rotational axis. However, in other embodiments, the shoulder includes one contact surface oriented at a non-perpendicular angle relative to the rotational axis. In yet other embodiments, the shoulder includes more than two contact surfaces oriented at a non-perpendicular angle relative to the rotational axis. In further embodiments, shoulder includes at least two contact surfaces oriented at a non-perpendicular angle relative to the rotational axis where a first contact surface is oriented at a different angle than the second contact surface.

In some embodiments, at least two of the contact surfaces of the shoulder define a corner angle in a range having an upper value, a lower value, or upper and lower values including any of 30°, 40°, 45°, 50°, 60°, 75°, 80°, 85°, 90°, 100°, 110°, 120°, 135°, or any values therebetween. For example, the shoulder may define a corner angle greater than 30°. In other examples, the shoulder may form a corner angle less than 135°. In yet other examples, the shoulder may define a corner angle between 30° and 135°. In further examples, the shoulder may define a corner angle between 60° and 120°. In at least one example, the shoulder may define a corner angle of 90°.

In some embodiments, the rotationally independent shoulder of the tool has two contact surfaces that complementarily mate with an outer surface of workpieces to rotationally lock the shoulder to the corner formed by the workpieces. In such examples, the shoulder can apply a compressive force to limit and/or prevent the formation of flash on the outer surface of the workpieces while the pin FSPs the workpieces. For example, the tool may be moved along a longitudinal corner weld of the workpieces with the shoulder remaining substantially rotationally stationary. The rotationally locked shoulder relative to the workpieces further limits the size of the heat affected zone.

As described herein, a tool according to some embodiments of the present disclosure has one or more thermal elements positioned on the shoulder. In some examples, the thermal element is positioned on a top surface axially opposite the contact surface of the shoulder. In some examples, the thermal element is positioned on a radially outward surface or edge of the shoulder. In some embodiments, the thermal element is a heating element to heat the shoulder and/or the workpiece, such as pre-heating the workpiece before the pin FSPs the workpiece material. In some embodiments, the thermal element is a cooling element to cool the shoulder and/or the workpiece, such as cooling the workpiece material after the pin FSPs the workpiece material.

In some embodiments, a heating thermal element is positioned on a top surface of the shoulder. Because the shoulder rotates more slowly and/or remains stationary relative to the pin, in some embodiments, a heating thermal element may have one or more conduits connected thereto. For example, a stationary shoulder may have an electrical conduit (e.g., a wire) connecting a resistive heating thermal element to a power source without the shoulder pulling on the wire. In another example, a stationary shoulder may have a fluid conduit connecting a radiant heating thermal element to a hot fluid source without the shoulder pulling on the conduit.

In some embodiments, a cooling thermal element is positioned on a top surface of the shoulder. Because the shoulder rotates more slowly and/or remains stationary relative to the pin, in some embodiments, a cooling thermal element may have one or more conduits connected thereto. For example, a stationary shoulder may have an electrical conduit (e.g., a wire) connecting a Peltier cooling thermal element to a power source without the shoulder pulling on the wire. In another example, a stationary shoulder may have a liquid conduit connecting a liquid cooling thermal element to a cold liquid source without the shoulder pulling on the conduit.

In some embodiments, the cooling thermal element may be or include a passive cooling element, such as fins, pins, rods, and other surface features that increase surface area of the top surface to conduct and radiate away heat from the shoulder. In some embodiments rotation of the shoulder around the rotational axis during FSP (such as due to friction or drag with the pin) may cause the passive cooling element(s) to move air or other fluid around the tool, further passively cooling at least a portion of the tool.

In some embodiments, the shoulder is asymmetric relative to the rotational axis. In some embodiments, a surface area of the shoulder is asymmetric relative to the rotational axis. For example, the increased surface area on one side of the shoulder relative to the rotational axis may produce a net frictional force on the shoulder, applying a torque around the rotational axis. In some embodiments, a mass of the shoulder is asymmetric relative to the rotational axis. In conventional FSP tools with a shoulder that rotates at the speed of the bit, an asymmetric mass causes dangerously unstable oscillations. A stationary or low-speed shoulder according to the present disclosure can allow for an asymmetric mass.

As the tool is translated relative to the workpiece (e.g., across a weld), the portion of the asymmetric shoulder with a larger radius from the rotational axis (the foot) will experience a torque based on friction and the direction of movement of the tool across the workpiece. The foot will trail behind relative to the direction of movement of the tool across the workpiece, further limiting and/or preventing rotation of the shoulder as the pin rotates during FSP.

In some embodiments, systems and methods of friction stir processing according to the present disclosure are related to any of the sections below:

[A1] In some embodiments, a friction-stir processing tool includes a pin, a shoulder, and a bearing surface. The pin and shoulder are rotatable around a rotational axis. The bearing surface is between the shoulder and pin, and the bearing surface allows the shoulder and pin to rotate independently relative to one another around the rotational axis on the bearing surface.

[A2] In some embodiments, the friction-stir processing tool of [A1] includes a race bearing at the bearing surface.

[A3] In some embodiments, the friction-stir processing tool of [A1] includes a thrust bearing at the bearing surface.

[A4] In some embodiments, the friction-stir processing tool of [A1] includes a bearing material at the bearing surface.

[A5] In some embodiments, the bearing material of [A4] is rotationally independent of the shoulder and pin.

[A6] In some embodiments, the friction-stir processing tool of any of [A1] through [A5] includes a bearing element with a movable component at the bearing surface.

[A7] In some embodiments, at least part of the shoulder of any of [A1] through [A6] is planar.

[A8] In some embodiments, at least part of the shoulder of any of [A1] through [A7] is concave.

[A9] In some embodiments, at least part of the shoulder of any of [A1] through [A8] is convex.

[A10] In some embodiments, at least part of the shoulder of any of [A1] through [A9] defines a corner angle between 30° and 135°.

[A11] In some embodiments, the corner angle of [A10] is between 60° and 120°.

[A12] In some embodiments, the shoulder of any of [A1] through [A11] does not directly contact a tool holder.

[B1] In some embodiments, friction-stir processing device includes a pin, a shoulder, a bearing surface, and a thermal element. The pin and shoulder are rotatable around a rotational axis. The bearing surface is between the shoulder and pin, and the bearing surface allows the shoulder and pin to rotate independently relative to one another around the rotational axis on the bearing surface. The shoulder has a contact surface in a first axial direction. The thermal element is positioned on a top surface of the shoulder axially opposite the contact surface.

[B2] In some embodiments, the thermal element of [B1] includes a heating thermal element configured to heat the shoulder.

[B3] In some embodiments, the heating thermal element [B2] is a resistive heating thermal element.

[B4] In some embodiments, the thermal element of [B1] includes a cooling thermal element configured to cool the shoulder.

[B5] In some embodiments, the cooling thermal element of [B4] includes passive cooling elements.

[C1] In some embodiments, a friction-stir processing tool includes a pin, an asymmetric shoulder, and a bearing surface. The pin and shoulder are rotatable around a rotational axis. The bearing surface is between the shoulder and pin, and the bearing surface allows the shoulder and pin to rotate independently relative to one another around the rotational axis on the bearing surface.

[C2] In some embodiments, a surface area of the shoulder of [C1] is asymmetric around the rotational axis.

[C3] In some embodiments, a mass of the shoulder of [C1] or [C2] is asymmetric around the rotational axis.

The articles “a,” “an,” and “the” are intended to mean that there are one or more of the elements in the preceding descriptions. The terms “comprising,” “including,” and “having” are intended to be inclusive and mean that there may be additional elements other than the listed elements. Additionally, it should be understood that references to “one embodiment” or “an embodiment” of the present disclosure are not intended to be interpreted as excluding the existence of additional embodiments that also incorporate the recited features. For example, any element described in relation to an embodiment herein may be combinable with any element of any other embodiment described herein, unless such features are mutually exclusive. Numbers, percentages, ratios, or other values stated herein are intended to include that value, and also other values that are “about” or “approximately” the stated value, as would be appreciated by one of ordinary skill in the art encompassed by embodiments of the present disclosure. A stated value should therefore be interpreted broadly enough to encompass values that are at least close enough to the stated value to perform a desired function or achieve a desired result. The stated values include at least the variation to be expected in a suitable manufacturing or production process.

A person having ordinary skill in the art should realize in view of the present disclosure that equivalent constructions do not depart from the spirit and scope of the present disclosure, and that various changes, substitutions, and alterations may be made to embodiments disclosed herein without departing from the spirit and scope of the present disclosure. Equivalent constructions, including functional “means-plus-function” clauses are intended to cover the structures described herein as performing the recited function, including both structural equivalents that operate in the same manner, and equivalent structures that provide the same function. It is the express intention of the applicant not to invoke means-plus-function or other functional claiming for any claim except for those in which the words ‘means for’ appear together with an associated function. Each addition, deletion, and modification to the embodiments that falls within the meaning and scope of the claims is to be embraced by the claims.

The terms “approximately,” “about,” and “substantially” as used herein represent an amount close to the stated amount that still performs a desired function or achieves a desired result. For example, the terms “approximately,” “about,” and “substantially” may refer to an amount that is within less than 5% of, within less than 1% of, within less than 0.1% of, and within less than 0.01% of a stated amount. Further, it should be understood that any directions or reference frames in the preceding description are merely relative directions or movements. For example, any references to “up” and “down” or “above” or “below” are merely descriptive of the relative position or movement of the related elements.

The present disclosure may be embodied in other specific forms without departing from its spirit or characteristics. The described embodiments are to be considered as illustrative and not restrictive. The scope of the disclosure is, therefore, indicated by the appended claims rather than by the foregoing description. Changes that come within the meaning and range of equivalency of the claims are to be embraced within their scope.

What is claimed is:

1. A friction-stir processing (FSP) tool comprising:
a pin rotatable around a rotational axis;
a shoulder rotatable around the rotational axis; and
a bearing surface between the shoulder and pin, wherein the shoulder and pin are independently rotatable relative to one another around the rotational axis on the bearing surface.

2. The FSP tool of claim 1, further comprising a race bearing at the bearing surface.

3. The FSP tool of claim 1, further comprising a thrust bearing at the bearing surface.

4. The FSP tool of claim 1, further comprising a bearing material at the bearing surface.

5. The FSP tool of claim 4, wherein the bearing material is rotationally independent of the shoulder and pin.

6. The FSP tool of claim 1, further comprising a bearing element with a movable component at the bearing surface.

7. The FSP tool of claim 1, wherein at least part of the shoulder is planar.

8. The FSP tool of claim 1, wherein at least part of the shoulder is concave.

9. The FSP tool of claim 1, wherein at least part of the shoulder is convex.

10. The FSP tool of claim 1, wherein at least part of the shoulder defines a corner angle between 30° and 135°.

11. The FSP tool of claim 10, wherein the corner angle is between 60° and 120°.

12. The FSP tool of claim 1, wherein the shoulder does not directly contact a tool holder.

13. A friction-stir processing (FSP) device comprising:
a pin rotatable around a rotational axis;
a shoulder rotatable around the rotational axis and having a contact surface in a first axial direction;
a bearing surface between the shoulder and pin, wherein the shoulder and pin are rotatable relative to one another around the rotational axis on the bearing surface; and
a thermal element positioned on a top surface of the shoulder axially opposite the contact surface.

14. The FSP device of claim 13, wherein the thermal element includes a heating thermal element configured to heat the shoulder.

15. The FSP device of claim 14, wherein the heating thermal element is a resistive heating thermal element.

16. The FSP device of claim 13, wherein the thermal element includes a cooling thermal element configured to cool the shoulder.

17. The FSP device of claim 16, wherein the cooling thermal element includes passive cooling elements.

18. A friction-stir processing (FSP) device comprising:
a pin rotatable around a rotational axis;
an asymmetric shoulder rotatable around the rotational axis; and
a bearing surface between the shoulder and pin, wherein the shoulder and pin are independently rotatable relative to one another around the rotational axis.

19. The FSP device of claim 18, wherein a surface area of the shoulder is asymmetric around the rotational axis.

20. The FSP device of claim 18, wherein a mass of the shoulder is asymmetric around the rotational axis.
